(19) United States
(12) Patent Application Publication
(10) Pub. No.: US 2015/0328881 A1
(43) Pub. Date: Nov. 19, 2015

(54) INKJET PRINTER

(71) Applicant: RISO KAGAKU CORPORATION, Tokyo (JP)

(72) Inventor: Takashi EBISAWA, Ibaraki (JP)

(73) Assignee: RISO KAGAKU CORPORATION, Tokyo (JP)

(21) Appl. No.: 14/702,001

(22) Filed: May 1, 2015

(30) Foreign Application Priority Data
May 14, 2014 (JP) 2014-100243

(51) Int. Cl. B41J 2/045

(52) U.S. Cl. CPC B41J 2/0451; B41J 2/04586

(57) ABSTRACT

In an ejection test of a clear ink nozzle, a controller drives a printing unit to eject a clear ink and a color ink to a sheet such that a dot formed by the clear ink ejected from the clear ink nozzle and a dot formed by the color ink ejected from a color ink nozzle at least partially overlap each other on the sheet, and then determines presence and absence of misfiring in the clear ink nozzle based on a degree of spreading of the dot of the color ink on the sheet after the driving.

### CROSS REFERENCE TO RELATED APPLICATION

This application is based upon and claims the benefit of priority from the prior Japanese Patent Application No. 2014-100243, filed on May 14, 2014, the entire contents of which are incorporated herein by reference.

### BACKGROUND

1. Technical Field

The disclosure relates to an inkjet printer which performs printing by ejecting inks from inkjet heads.

2. Related Art

An inkjet printer which performs printing by ejecting inks from nozzles of inkjet heads is known.

In the inkjet printer, there is a case where the ink cannot be ejected from a nozzle due to clogging of the nozzle with dust and the like. When there is such a misfiring nozzle, the print quality decreases. For example, when there is a misfiring nozzle in a line inkjet printer which performs printing by ejecting inks to a sheet from fixed inkjet heads while transferring the sheet, a white stripe is formed in a transferring direction of the sheet and the print quality greatly decreases. Accordingly, there is a need to perform maintenance for a misfiring nozzle, if any.

In the inkjet printer, an ejection test is performed to determine the presence and absence of a misfiring nozzle. In the ejection test, the inkjet printer prints a predetermined ejection pattern. After the printing, a scanner scans a printed image and generates image data. Then, the image data is analyzed to determine whether the ink is ejected from each of the nozzles.

Meanwhile, some inkjet printers use a colorless-transparent clear ink. For example, the clear ink is sometimes ejected on the color ink in order to improve the density and gloss of the printed matter.

Even if the ejection test pattern is printed by using the clear ink as in the ejection test of the color ink, the printed image is almost colorless. Accordingly, the ejection test of the nozzles from which the clear ink is ejected is difficult.

In view of this, Japanese Unexamined Patent Application Publication No. 2009-286139 discloses a technique of determining the presence and absence of misfiring in the nozzles from which the clear ink is ejected, based on the density of a test pattern in which the clear ink is applied on the color ink.

### SUMMARY

The aforementioned technique utilizes a change in the density of a color ink from that of the color ink only to that of the color ink on which the clear ink is applied. For a clear ink which changes only slightly the density of a color ink when applied on the color ink, however, this technique still has a difficulty detecting misfiring of the nozzles for clear ink ejection.

An object of the present invention is to provide an inkjet printer which can determine the presence and absence of misfiring in nozzles for clear ink ejection without depending on density change of a color ink occurring when the clear ink is applied on the color ink.

An inkjet printer in accordance with some embodiments includes: a printing unit including a color ink nozzle to eject a color ink to a sheet and a clear ink nozzle to eject a colorless-transparent clear ink to the sheet, the clear ink causing bleeding with the color ink; a controller configured to control the printing unit and determine presence and absence of misfiring in the clear ink nozzle. In an ejection test of the clear ink nozzle, the controller drives the printing unit to eject the clear ink and the color ink to the sheet such that a dot formed by the clear ink ejected from the clear ink nozzle and a dot formed by the color ink ejected from the color ink nozzle at least partially overlap each other on the sheet, and then determines the presence and absence of misfiring in the clear ink nozzle based on a degree of spreading of the dot of the color ink on the sheet after the driving.

In the configuration described above, a printing control part causes the printing unit to eject the clear ink and the color ink to the sheet in such a way that the dot formed by the clear ink ejected from the clear ink nozzle and the dot formed by the color ink ejected from the color ink nozzle at least partially overlap each other. An ejection determination part determines the presence and absence of misfiring in the clear ink nozzle based on the degree of spreading of the color ink on the sheet. The inkjet printer can thereby determine the presence and absence of misfiring in the clear ink nozzle without depending on density change occurring when the color ink and the clear ink overlap each other.

The printing unit may include a color ink nozzle array having a plurality of the color ink nozzles arranged in a nozzle arrangement direction, and a clear ink nozzle array arranged in parallel with the color ink nozzle array and having a plurality of the clear ink nozzles arranged in the nozzle arrangement direction. The printing unit may eject the color ink and the clear ink to the sheet being moving relative to the color ink nozzle array and the clear ink nozzle array in a relative movement direction orthogonal to the nozzle arrangement direction. In the ejection test of the clear ink nozzles, the controller may drive the printing unit to print a pattern in which: dots formed by the clear ink ejected from clear ink nozzles adjacent to each other are offset from each other in the relative movement direction; an interval of a predetermined number of pixels or greater is provided between centers of dots of the clear ink whose positions in the relative movement direction are the same and which are adjacent to each other in the nozzle arrangement direction; and a dot of the color ink is formed to at least partially overlap each dot of the clear ink.

In the configuration described above, the printing control part causes the printing unit to print the pattern in which: the dots formed by the clear ink ejected from the clear ink nozzles adjacent to each other are offset from each other in the relative movement direction; the interval of the predetermined number of pixels or greater is provided between the centers of the dots of the clear ink whose positions in the relative movement direction are the same and which are adjacent to each other in the nozzle arrangement direction; and the dot of the color ink is formed to at least partially overlap each of the dots of the clear ink. This makes it possible to avoid an effect of the adjacent clear ink nozzles and determine the presence and absence of misfiring in the clear ink nozzles at high accuracy.

### BRIEF DESCRIPTION OF DRAWINGS

FIG. 1 is a block diagram showing a configuration of an inkjet printer in an embodiment.

FIG. 2 is a schematic configuration diagram of a transfer unit and a printing unit in the inkjet printer shown in FIG. 1.

FIG. 3 is a view showing nozzles of an inkjet head.

FIG. 4 is a flowchart for explaining a procedure of an ejection test for an inkjet head of a clear ink.

FIG. 5 is a view showing a clear ink ejection test pattern.

FIG. 6 is a view explaining spreading of a black ink.

FIG. 7 is a view showing an example of density distribution in a printed image of the clear ink ejection test pattern.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

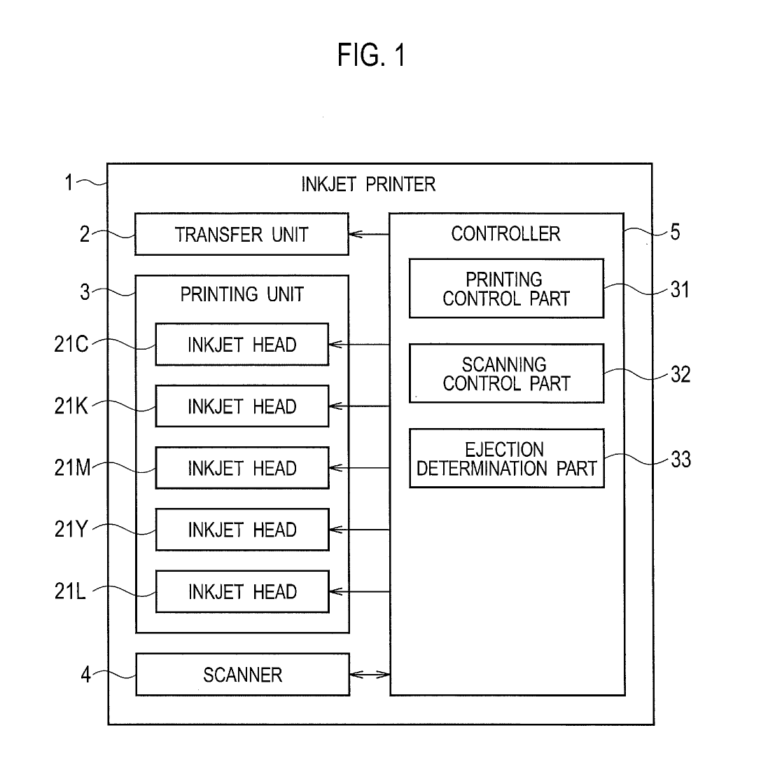

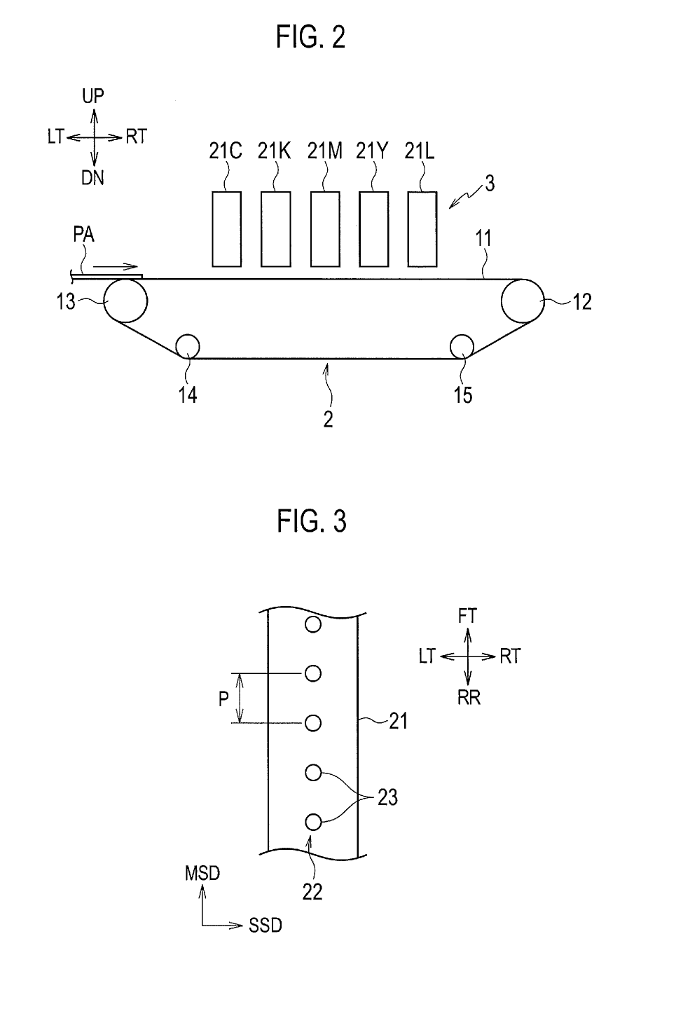

FIG. 1 is a block diagram showing a configuration of an inkjet printer 1 in an embodiment of the present invention. FIG. 2 is a schematic configuration diagram of a transfer unit 2 and a printing unit 3 in the inkjet printer 1 shown in FIG. 1. FIG. 3 is a view showing nozzles 23 in each of inkjet heads 21 (21C, 21K, 21M, 21Y, and 21L).

In the following description, a direction orthogonal to a sheet surface of FIG. 2 is a front-rear direction and a direction toward the front face of the sheet surface is a frontward direction. Moreover, up, down, left, and right in the sheet surface of FIG. 2 are upward, downward, leftward, and rightward directions. In FIG. 2, a direction from left to right is a transfer direction of a sheet PA which is a printing medium. Upstream and downstream in the following description mean upstream and downstream in the transfer direction. In the drawings, the rightward direction, the leftward direction, the upward direction, the downward direction, the frontward direction, and a rearward direction are denoted by RT, LT, UP, DN, FT, and RR, respectively. Moreover, in the drawings, the transfer direction (sub-scanning direction) of the sheet PA and the front-rear direction (main scanning direction) are denoted by SSD and MSD, respectively.

As shown in FIG. 1, the inkjet printer 1 includes the transfer unit 2, the printing unit 3, a scanner 4, and a controller 5.

The transfer unit 2 transfers the sheet PA. As shown in FIG. 2, the transfer unit 2 includes a transfer belt 11, a drive roller 12, and driven rollers 13, 14, and 15.

The transfer belt 11 transfers the sheet PA while sucking and holding the sheet PA. The transfer belt 11 is an annular belt wound around the drive roller 12 and the driven rollers 13 to 15. Many belt holes for sucking and holding the sheet PA are formed in the transfer belt 11. The transfer belt 11 sucks and holds the sheet PA on a top surface thereof by using sucking force generated at the belt holes by drive of a fan (not illustrated). The transfer belt 11 is rotated clockwise in FIG. 2 to transfer the sucked and held sheet PA rightward.

The drive roller 12 supports the transfer belt 11 together with the driven rollers 13 to 15 and rotates the transfer belt 11. The drive roller 12 is driven by a not-illustrated motor.

The driven rollers 13 to 15 support the transfer belt 11 together with the drive roller 12. The driven rollers 13 to 15 are driven by the drive roller 12 via the transfer belt 11. The driven roller 13 is arranged on the left side of the drive roller 12 at the same height as the drive roller 12. The driven rollers 14 and 15 are arranged below the drive roller 12 and the driven roller 13 at substantially the same height while being spaced away from each other in a left-right direction.

The printing unit 3 ejects inks to the sheet PA transferred by the transfer unit 2 to print an image. The printing unit 3 is arranged above the transfer unit 2. The printing unit 3 includes the inkjet heads 21C, 21K, 21M, 21Y, and 21L. In a case of generally referring to the inkjet heads 21C, 21K, 21M, 21Y, and 21L, the alphabet letters (C, K, M, Y, and L) attached to the reference numerals are omitted and the inkjet heads are denoted by 21.

The inkjet heads 21 eject the inks to the sheet PA transferred by the transfer unit 2. The inkjet heads 21C, 21K, 21M, 21Y, and 21L are arranged side by side with each other in this order from the upstream side at predetermined intervals in the transfer direction (sub-scanning direction; relative movement direction) of the sheet PA. The inkjet heads 21C, 21K, 21M, and 21Y eject color inks of cyan (C), black (K), magenta (M), and yellow (Y), respectively. The inkjet head 21L ejects a colorless-transparent clear ink. The clear ink is applied to improve the density and gloss of a printed matter. In the embodiment, the clear ink is an ink which causes bleeding with the color inks used in the inkjet printer 1.

As shown in FIG. 3, each of the inkjet heads 21 has a nozzle array 22. FIG. 3 is a view of the inkjet head 21 from below. The nozzle array 22 includes multiple nozzles 23 arranged at a predetermined pitch in the front-rear direction (main scanning direction; nozzle arrangement direction) orthogonal to the transfer direction of the sheet PA. The positions of the nozzles 23 in the main scanning direction are the same among all of the nozzle arrays 22 provided respectively in the inkjet heads 21C, 21K, 21M, 21Y, and 21L. The nozzle array 22 of the inkjet head 21K is a color ink nozzle array and the nozzle array 22 of the inkjet head 21L is a clear ink nozzle array.

The inks are ejected from the nozzles 23. The cyan ink is ejected from the nozzles 23 of the inkjet head 21C, the black ink is ejected from the nozzles 23 of the inkjet head 21K, the magenta ink is ejected from the nozzles 23 of the inkjet head 21M, and the yellow ink is ejected from the nozzles 23 of the inkjet head 21Y. The clear ink is ejected from the nozzles 23 of the inkjet head 21L. The nozzles 23 are opened on bottom surfaces of the inkjet heads 21. In the inkjet heads 21, the number of droplets (droplet number) of the ink ejected from one nozzle 23 for one pixel can be changed to perform gradation printing in which the density is expressed by the number of droplets. The nozzles 23 in the inkjet head 21K are color ink nozzles and the nozzles 23 in the inkjet head 21L are clear ink nozzles.

The scanner 4 includes a platen (an original table), a light receiving element, a light source, a lens, a scanning mechanism, an automatic document (original) feeder, and the like (all not illustrated), and optically scans an image of an original to generate image data.

The controller 5 performs control processing in the inkjet printer 1. The controller 5 includes a CPU, a RAM, a ROM, a hard disk drive, and the like. The controller 5 has a printing control part 31, a scanning control part 32, and an ejection determination part 33. The parts of the controller 5 are implemented by the CPU operating according to a program stored in the hard disk drive.

The printing control part 31 controls operations of sheet transfer and ink ejection in printing in the inkjet printer 1. Specifically, the printing control part 31 performs control of causing the inkjet heads 21 of the printing unit 3 to eject the inks to print an image while causing the transfer unit 2 to transfer the sheet PA.

In an ejection test of the inkjet heads 21C, 21K, 21M, and 21Y configured to eject the color inks, the printing control part 31 controls the inkjet heads 21C, 21K, 21M, and 21Y to cause the inkjet heads 21C, 21K, 21M, and 21Y to print a predetermined color ink ejection test pattern. In the ejection test of the nozzles 23 of the inkjet head 21L configured to eject the clear ink, the printing control part 31 controls the inkjet heads 21K and 21L in the printing unit 3 to cause the inkjet heads 21K and 21L to print a clear ink ejection test pattern to be described later.

The scanning control part 32 controls the scanner 4 to cause the scanner 4 to scan an image of an original.

The ejection determination part 33 determines the presence and absence of misfiring in the nozzles 23 in the ejection tests. Specifically, in the ejection test of the inkjet heads 21C, 21K, 21M, and 21Y, the ejection determination part 33 determines the presence and absence of misfiring in the nozzles 23 based on image data generated by the scanner 4 scanning a printed image of the color ink ejection test pattern.

In the ejection test of the inkjet head 21L, the ejection determination part 33 determines the presence and absence of misfiring in the nozzles 23 based on image data generated by the scanner 4 scanning a printed image of the clear ink ejection test pattern. In the ejection test of the inkjet head 21L, the ejection determination part 33 determines the presence and absence of misfiring in the nozzles 23 based on a degree of spreading of the black ink on the sheet PA in the printed image of the clear ink ejection test pattern to be described later. Specifically, the ejection determination part 33 determines the presence and absence of misfiring in the nozzles 23 based on the line width of each of lines forming the clear ink ejection test pattern in the printed image of the clear ink ejection test pattern.

Next, a printing operation of the inkjet printer 1 is described.

When an instruction to start printing is given, the printing control part 31 drives and rotates the drive roller 12 of the transfer unit 2. The transfer belt 11 thereby rotates. When the sheet PA is fed from a not-illustrate feeding unit, the transfer unit 2 transfers the sheet PA. The printing control part 31 causes the inkjet heads 21C, 21K, 21M, 21Y, and 21L to eject the inks to the sheet PA transferred by the transfer unit 2, in accordance with image data of a printing target. An image is thereby printed on the sheet PA. A not-illustrated delivery unit delivers the printed sheet PA.

Next, the ejection tests in the inkjet printer 1 are described.

The ejection tests for the inkjet heads 21C, 21K, 21M, and 21Y configured to eject the color inks are performed in a publicly-known method.

Specifically, for example, in a case of performing the ejection test for the inkjet head 21C, the printing control part 31 performs control of causing the inkjet head 21C to print a predetermined color ink ejection test pattern on the sheet PA while causing the transfer unit 2 to transfer the sheet PA.

The printed sheet on which the color ink ejection test pattern is printed is set on the scanner 4 by an operator. Then, the operator operates a not-illustrated operation panel to instruct the scanner 4 to scan an image.

In response to this operation, the scanning control part 32 causes the scanner 4 to scan the printed image of the color ink ejection test pattern. The scanner 4 generates image data of the printed image of the color ink ejection test pattern.

When there is a misfiring nozzle 23 in the inkjet head 21C, a white stripe appears in the printed image of the color ink ejection test pattern. The ejection determination part 33 thus analyzes the image data of the printed image of the color ink ejection test pattern and determines whether there is a white stripe in the printed image. When there is a white stripe in the printed image, the ejection determination part 33 determines that there is misfiring in the nozzles 23.

The ejection tests for the inkjet heads 21K, 21M, and 21Y are performed in the same way as the aforementioned ejection test for the inkjet head 21C. When misfiring in the nozzles 23 is detected in the ejection test, maintenance is performed to eliminate the misfiring.

Next, the ejection test for the inkjet head 21L configured to eject the clear ink is described.

Note that, prior to the ejection test for the inkjet head 21L, the ejection test and maintenance for the inkjet head 21K is performed and the inkjet head 21K is checked that there is no misfiring nozzle 23 therein.

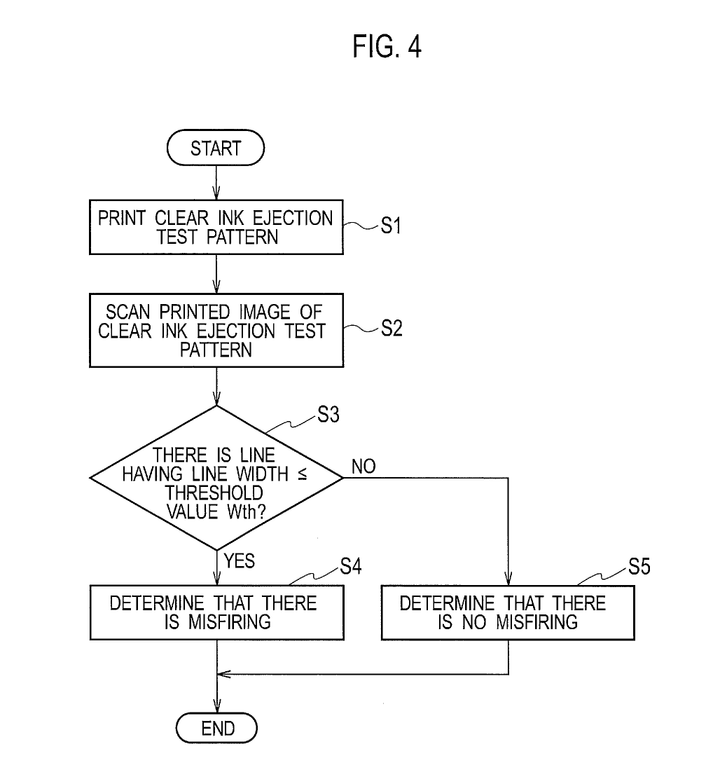

FIG. 4 is a flowchart for explaining a procedure of the ejection test for the inkjet head 21L.

In step S1 of FIG. 4, the printing control part 31 performs control of causing the inkjet heads 21K and 21L to print the clear ink ejection test pattern on the sheet SA while causing the transfer unit 2 to transfer the sheet SA.

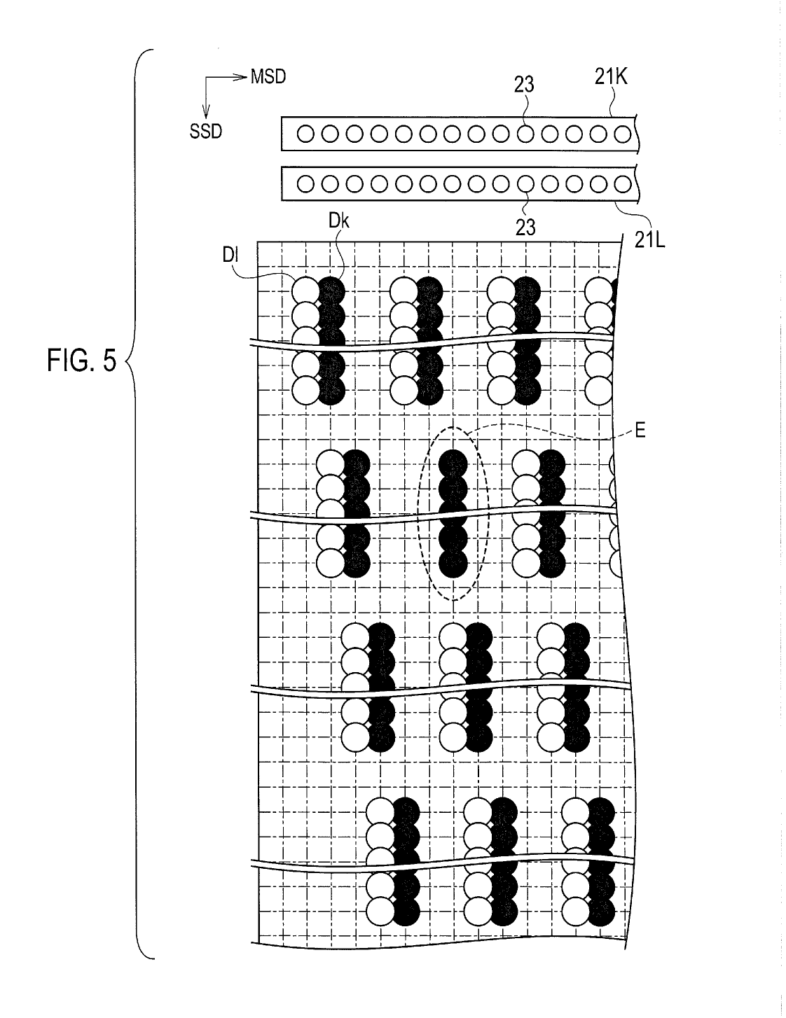

As shown in FIG. 5, the clear ink ejection test pattern is a pattern in which a line made of clear ink dots D1 is formed by the clear ink ejected from each of the nozzles 23 of the inkjet head 21L, the dots D1 formed in multiple pixels consecutive in the sub-scanning direction. The lines are formed of the dots D1 such that each adjacent two lines in the main scanning direction are offset in the sub-scanning direction. This enables the ejection test for all of the nozzles 23. Moreover, in the embodiment, the lines made of the dots D1 formed at the same position in the sub-scanning direction are arranged with a space for three lines left therebetween in the main scanning direction. Thus, the presence of sets of four lines offset in the sub-scanning direction enables the ejection test for all of the nozzles 23.

In other words, in the clear ink ejection test pattern, the dots D1 formed by the clear ink ejected from the nozzles 23 adjacent to each other in the inkjet head 21L are offset from each other in the sub-scanning direction. Moreover, an interval between the centers of the dots D1 whose positions in the sub-scanning direction are the same and which are adjacent to each other in the main scanning direction is four pixels.

In the clear ink ejection test pattern, the black ink is ejected from the nozzles 23 of the inkjet head 21K in such a way that the dots D1 of the clear ink and dots Dk of the black ink partially overlap one another. The black ink forming a dot Dk, which is partially overlapped by a dot D1 formed by each nozzle 23 of the inkjet head 21L for clear ink ejection, is ejected from the nozzle 23 of the inkjet head 21K adjacent in the main scanning direction to the above nozzle 23 of the inkjet head 21L.

Ejection amounts (droplet number) of the black ink and the clear ink for each dot in the clear ink ejection test pattern are set such that the dot Dk and the dot D1 partially overlap each other.

As described above, the clear ink ejected from the inkjet head 21L causes bleeding with the color inks. Accordingly, when the dots Dk and Dots D1 partially overlap one another on the sheet PA, the black ink and the color ink mix with each other and spreads due to color bleeding.

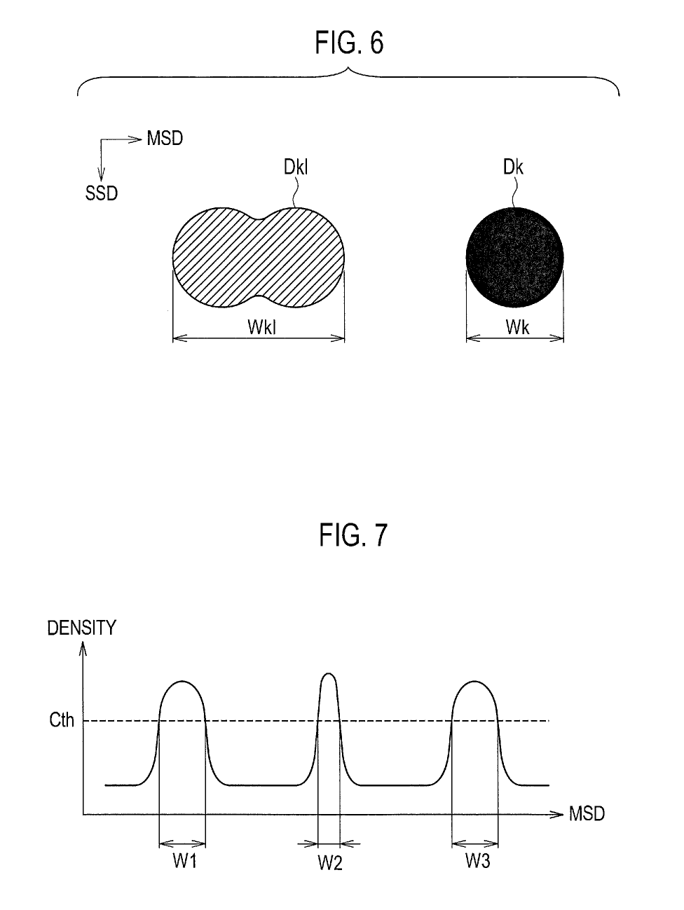

Due to this, when there is no misfiring in the nozzles 23 of the inkjet head 21L, the dots Dk and dots D1 mix with one another and form combined dots Dk1 shown in FIG. 6 in the printed image of the clear ink ejection test pattern. Meanwhile, when one of the nozzles 23 of the inkjet head 21L misfires, only the dots Dk of the black ink are formed as in the region E of FIG. 5.

Accordingly, in a portion of the printed image of the clear ink ejection test pattern which corresponds to the non-misfiring nozzle 23 of the inkjet head 21L, the line has a line width equal to the width Wk1 of the combined dot Dk1. Meanwhile, in a portion corresponding to the misfiring nozzle 23, the line has a line width equal to the width Wk of the dot Dk. The width Wk1 of the combined dot Dk1 is greater than the width Wk of the dot Dk.

The printed sheet on which the clear ink ejection test pattern is printed is set on the scanner 4 by the operator. Then, the operator operates the not-illustrated operation panel to instruct the scanner 4 to scan the image.

In response to this operation, in step S2 of FIG. 4, the scanning control part 32 causes the scanner 4 to scan the printed image of the clear ink ejection test pattern. The scanner 4 generates image data of the printed image of the clear ink ejection test pattern.

Then, in step S3, the ejection determination part 33 determines whether there is a line whose line width is equal to or smaller than a threshold value Wth among the lines forming the clear ink ejection test pattern, based on the image data of the printed image of the clear ink ejection test pattern.

Specifically, the ejection determination part 33 calculates the density of each pixel in the image data and determines a region in which the density is equal to or greater than a density threshold Cth as the printed image. Moreover, the ejection determination part 33 calculates the line width of each of the lines in the printed image. For example, when the density distribution in part of the image data of the printed image along the main scanning direction is as shown in FIG. 7, the line widths of the three lines included in this distribution are calculated as W1, W2, and W3, respectively.

After calculating the line widths, the ejection determination part 33 determines whether each of the line widths is equal to or smaller the threshold value Wth. Based on the result of this determination, the ejection determination part 33 determines whether there is a line whose line width is equal to or smaller the threshold value Wth. For example, when W1 and W3 in FIG. 7 are greater than the threshold value Wth and W2 in FIG. 7 is equal to or smaller than the threshold value Wth, the ejection determination part 33 determines that there is a line whose line width is equal to or smaller the threshold value Wth.

The line width in the printed image of the clear ink ejection test pattern shows a degree of spreading of the black ink. When the dot Dk and dot D1 mix with each other, the black ink spreads widely and the line width becomes equal to the width Wk1 of the combined dot Dk1. When no clear ink is ejected, the spreading of the black ink remains within the width Wk of the dot Dk.

The threshold value Wth is a threshold for detecting a line in which there no spreading of the black ink due to color bleeding with the clear ink, in the printed image of the clear ink ejection test pattern. The threshold value Wth is set to a value smaller than the width Wk1 of the combined dot Dk1.

Returning to FIG. 4, when the ejection determination part 33 determines that there is a line whose line width is equal to or smaller than the threshold value Wth (YES in step S3), the ejection determination part 33 determines in step S4 that there is misfiring in the nozzles 23 of the inkjet head 21L, and terminates the ejection test.

When the ejection determination part 33 determines that there is no line whose line width is equal to or smaller than the threshold value Wth, the ejection determination part 33 determines in step S5 that there is no misfiring in the nozzles 23 of the inkjet head 21L, and terminates the ejection test.

When the ejection determination part 33 determines that there is misfiring in the nozzles 23 of the inkjet head 21L, maintenance is performed to eliminate the misfiring.

As described above, in the inkjet printer 1, the clear ink and the black ink are ejected to the sheet PA in such a way that the dots D1 and the dots Dk partially overlap one another in the ejection test of the inkjet head 21L. Then, the ejection determination part 33 determines the presence and absence of misfiring in the nozzle 23 of the inkjet head 21L based on the degree of spreading of the black ink on the sheet PA. The inkjet printer 1 can thereby determine the presence and absence of misfiring in the nozzles 23 from which the clear ink is ejected, without depending on density change of the color ink which occurs when the clear ink is applied on the color ink.

Moreover, in the inkjet printer 1, the clear ink ejection test pattern of FIG. 5 is used in the ejection test of the inkjet head 21L. In the clear ink ejection test pattern, the dots D1 formed by the clear ink ejected from the nozzles 23 adjacent to each other in the inkjet head 21L are offset from each other in the sub-scanning direction. Moreover, the interval between the centers of the dots D1 whose positions in the sub-scanning direction are the same and which are adjacent to each other in the main scanning direction is four pixels. An interval of four pixels can prevent a dot Dk partially overlapping one dot D1 from overlapping another dot D1 at all. Using such a clear ink ejection test pattern makes it possible to avoid an effect of adjacent nozzles 23 and determine the presence and absence of misfiring in the nozzles 23 at high accuracy.

Although the dots D1 and the dots Dk are made to partially overlap one another in the ejection test of the inkjet head 21L in the embodiment, the dots D1 and the dots Dk may completely overlap one another. Since the black ink mixes with the clear ink and spreads also in this case, it is possible to determine the presence and absence of misfiring in the nozzles 23 of the inkjet head 21L based on the degree of spreading of the black ink.

Moreover, although the black ink is used for the clear ink ejection test of the inkjet head 21L in the embodiment, other color inks may be used.

Furthermore, although the clear ink ejection test pattern of FIG. 5 is used in the embodiment, the pattern used for the clear ink ejection test is not limited to this pattern. Any pattern may be used as long as dots formed by the clear ink ejected from clear ink nozzles adjacent to each other are offset from each other in the sub-scanning direction, and an interval of a predetermined number of pixels or greater is provided between the centers of dots of the clear ink whose positions in the sub-scanning direction are the same and which are adjacent to each other in the main scanning direction. In this case, the interval between the centers of the dots of the clear ink whose positions in the sub-scanning direction are the same and which are adjacent to each other in the main scanning direction is set such that a dot of the color ink corresponding one dot of the clear ink may not overlap another dot of the clear ink at all.

Moreover, in the embodiment, description is given of a configuration in which the inkjet head 21L for the clear ink is arranged downstream of the inkjet heads 21C, 21K, 21M, and 21Y for the color inks and the clear ink is applied after the color inks. However, the present invention is not limited to this configuration and a configuration in which the clear ink is applied before the color inks may be employed.

Furthermore, in the embodiment, description is given of a line inkjet printer which performs printing while transferring the sheet. However, the present invention can be applied to any inkjet printer which performs printing by ejecting inks to a sheet being moving relative to inkjet heads. For example, the present invention can be applied to a serial inkjet printer which performs printing while moving inkjet heads.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. An inkjet printer comprising:
a printing unit comprising a color ink nozzle to eject a color ink to a sheet and a clear ink nozzle to eject a colorless-transparent clear ink to the sheet, the clear ink causing bleeding with the color ink;
a controller configured to control the printing unit and determine presence and absence of misfiring in the clear ink nozzle,
wherein, in an ejection test of the clear ink nozzle, the controller
drives the printing unit to eject the clear ink and the color ink to the sheet such that a dot formed by the clear ink ejected from the clear ink nozzle and a dot formed by the color ink ejected from the color ink nozzle at least partially overlap each other on the sheet, and then
determines the presence and absence of misfiring in the clear ink nozzle based on a degree of spreading of the dot of the color ink on the sheet after the driving.

2. The inkjet printer according to claim 1,
wherein the printing unit comprises:
a color ink nozzle array having a plurality of the color ink nozzles arranged in a nozzle arrangement direction; and
a clear ink nozzle array arranged in parallel with the color ink nozzle array and having a plurality of the clear ink nozzles arranged in the nozzle arrangement direction,
wherein the printing unit ejects the color ink and the clear ink to the sheet being moving relative to the color ink nozzle array and the clear ink nozzle array in a relative movement direction orthogonal to the nozzle arrangement direction, and
wherein, in the ejection test of the clear ink nozzles, the controller drives the printing unit to print a pattern in which:
dots formed by the clear ink ejected from clear ink nozzles adjacent to each other are offset from each other in the relative movement direction;
an interval of a predetermined number of pixels or greater is provided between centers of dots of the clear ink whose positions in the relative movement direction are the same and which are adjacent to each other in the nozzle arrangement direction; and
a dot of the color ink is formed to at least partially overlap each dot of the clear ink.
